(19) United States
(12) Patent Application Publication
(10) Pub. No.: US 2023/0215449 A1
(43) Pub. Date: Jul. 6, 2023

(54) VOICE REINFORCEMENT IN MULTIPLE SOUND ZONE ENVIRONMENTS

(71) Applicant: CERENCE OPERATING COMPANY, Burlington, MA (US)

(72) Inventors: Markus BUCK, Aachen (DE); Philipp BULLING, Aachen (DE); Stefan RICHARDT, Aachen (DE)

(73) Assignee: CERENCE OPERATING COMPANY, Burlington, MA (US)

(21) Appl. No.: 18/057,268

(22) Filed: Nov. 21, 2022

Related U.S. Application Data
(60) Provisional application No. 63/295,062, filed on Dec. 30, 2021.

(51) Int. Cl. G10L 21/0208; H04R 3/02; G10L 15/20

(52) U.S. Cl. CPC G10L 21/0208; H04R 3/02; G10L 15/20; H04R 2499/13; G10L 2021/02082; G10L 2021/02087

(57) ABSTRACT

Microphone signal is received from at least one microphone. AEC produces an echo cancelled microphone signal using first adaptive filters to estimate and cancel feedback that is a result of the environment. AFC produces a processed microphone signal using second adaptive filters to estimate and cancel feedback resulting from application of the reinforced voice signal within the environment. The uttered speech is reinforced in the processed microphone signal to produce the reinforced voice signal. The reinforced voice signal and the audio signal is applied to the loudspeakers. A step size of adjustment of the second adaptive filters may be increased responsive to detection of reverberation in the microphone signal. The reverberation that is used to control the step size of the second adaptive filters may be added artificially. This may provide multiple benefits including improving adjustment of the second adaptive filters and also improving the sound impression of the voice.

### CROSS-REFERENCE TO RELATED APPLICATIONS

This application claims the benefit of U.S. provisional application Ser. No. 63/295,062, filed Dec. 30, 2021, the disclosure of which is hereby incorporated in its entirety by reference herein.

### TECHNICAL FIELD

Aspects of the disclosure generally relate to voice reinforcement in multiple sound zone environments.

### BACKGROUND

Modern vehicle multimedia systems often comprise vehicle interior communication (voice processor) systems, which can improve the communication between passengers, especially when high background noise levels are present. Particularly, it is important to provide means for improving the communication between passengers in the backseat and the front seat of the vehicle, since the direction of speech produced by a front passenger is opposite to the direction in which the passenger in the rear seat is located. To improve the communication, speech produced by a passenger is recorded with one or more microphones and reproduced by loudspeakers that are located in close proximity to the listening passengers. As a consequence, sound emitted by the loudspeakers may be detected by the microphones, leading to reverb/echo or feedback. The loudspeakers may also be used to reproduce audio signals from an audio source, such as a radio, a compact disc (CD) player, a navigation system and the like. Again, these audio signal components are detected by the microphone and are put out by the loudspeakers, again leading to reverb or feedback.

Furthermore, the vehicle passengers may want to be entertained during their journey. For this purpose, a karaoke system can be provided inside the vehicle. Such a karaoke system suffers from the same drawbacks as a vehicle voice processor system, meaning that the reproduction of the voice from a singing passenger is prone to reverb and feedback.

### SUMMARY

In one or more illustrative examples, microphone signals are received from at least one microphone. Acoustic echo cancellation (AEC) of the microphone signal is performed to produce an echo cancelled microphone signal. The AEC uses first adaptive filters to estimate and cancel feedback that is a result of the environment. Acoustic feedback cancellation (AFC) of the echo cancelled microphone signal is performed to produce an echo and feedback cancelled microphone signal. The AFC uses second adaptive filters to estimate and cancel feedback resulting from application of the reinforced voice signal within the environment. The uttered speech in the echo and feedback cancelled microphone signal is applied to produce the reinforced voice signal. The reinforced voice signal and the audio signal are applied to the loudspeakers for reproduction in the environment.

In one or more illustrative examples, a method for sound signal processing in a vehicle multimedia system is provided. A microphone signal is received from at least one microphone. The microphone signal includes a first voice signal component that corresponds to uttered speech, a second voice signal component that corresponds to a reinforced voice signal as reproduced by loudspeakers in an environment, and an audio signal component corresponding to an audio signal as reproduced by the loudspeakers. AEC of the microphone signal is performed to produce an echo cancelled microphone signal, the AEC using first adaptive filters to estimate and cancel feedback that is a result of the environment. AFC of the echo cancelled microphone signal is performed to produce a processed microphone signal, the AFC using second adaptive filters to estimate and cancel feedback resulting from application of the reinforced voice signal within the environment. The uttered speech in the processed microphone signal is reinforced to produce the reinforced voice signal. The reinforced voice signal and the audio signal are applied to the loudspeakers for reproduction in the environment.

In one or more illustrative examples, a non-transitory computer-readable medium includes instructions for sound signal processing in a vehicle multimedia system that, when executed by a voice processor system, cause the voice processor system to perform operations including to receive a microphone signal from at least one microphone, the microphone signal including a first voice signal component that corresponds to uttered speech, a second voice signal component that corresponds to a reinforced voice signal as reproduced by loudspeakers in an environment, and an audio signal component corresponding to an audio signal as reproduced by the loudspeakers; perform AEC of the microphone signal to produce an echo cancelled microphone signal, the AEC using first adaptive filters to estimate and cancel feedback that is a result of the environment; perform AFC of the echo cancelled microphone signal to produce a processed microphone signal, the AFC using second adaptive filters to estimate and cancel feedback resulting from application of the reinforced voice signal within the environment; reinforce the uttered speech in the processed microphone signal to produce the reinforced voice signal; and apply the reinforced voice signal and the audio signal to the loudspeakers for reproduction in the environment.

### BRIEF DESCRIPTION OF THE DRAWINGS

FIG. 1 illustrates an example multichannel sound system providing for voice reinforcement within an environment having multiple sound zones;

FIG. 2 illustrates further aspects of the operation of the voice processor system;

FIG. 3 illustrates an example portion of the multichannel sound system illustrating an example of electro-acoustic feedback within the multichannel sound system;

FIG. 4 illustrates an example portion of the multichannel sound system illustrating an example of the use of acoustic feedback cancellation to combat the electro-acoustic feedback within the multichannel sound system;

FIG. 5 illustrates an example of a portion of the multichannel sound system illustrating step-size control for acoustic feedback cancellation with artificially added reverberation;

FIG. 6 illustrates an example graph of local speech and loudspeaker signals showing the artificially added reverberation;

FIG. 7 illustrates an example process for providing voice reinforcement within an environment having multiple sound zones; and

FIG. 8 illustrates an example process for the operation of the acoustic feedback cancellation of the voice processor system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

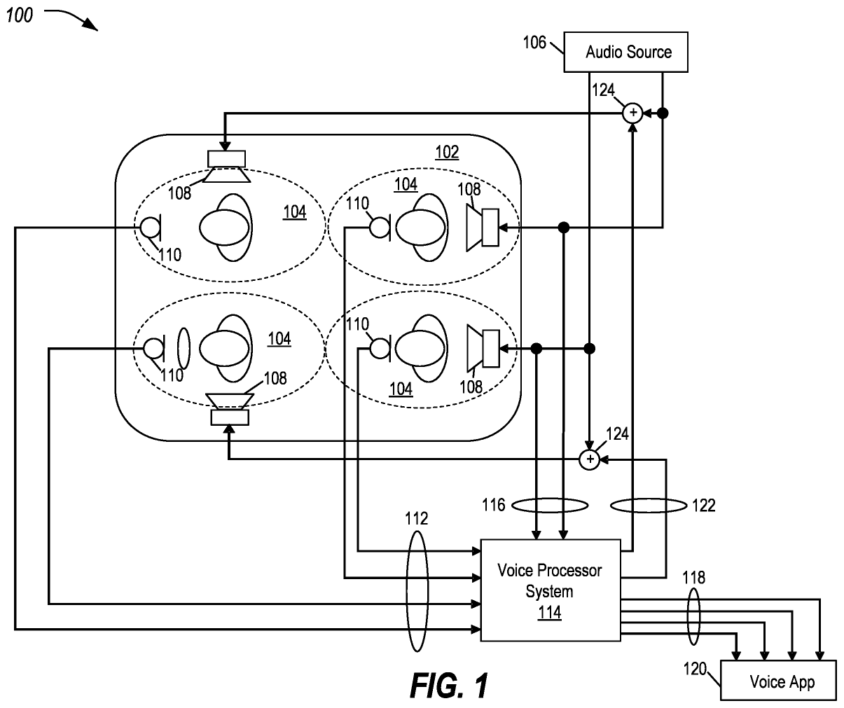

FIG. 1 illustrates an example multichannel sound system 100 providing for voice reinforcement within an environment 102 having multiple sound zones 104. The multichannel sound system 100 may include an audio source 106, loudspeakers 108, microphones 110, a voice processor system 114, and a voice reinforcement application 120. The voice reinforcement application 120 may be programmed to control the voice processor system 114 to facilitate the vocal reinforcement within the environment 102. As discussed in detail herein, the voice reinforcement application 120 may activate and control the features for signal processing to cause the voice processor system 114 to utilize amplification and reverb or other sound effects to reinforce voice signals captured by the microphones 110 within the multiple sound zone environment 102. The reinforcement may include localizing the voice signal within the multiple sound zone environment 102, identifying the loudspeakers 108 closest to the person talking, and using that feedback to reinforce the voice output using the identified loudspeakers 108.

The environment 102 may be a room or other enclosed area such as a concert hall, stadium, restaurant, auditorium, or vehicle cabin. In another example, the environment 102 may be an outdoor or at least partially unenclosed area or structure, such as an amphitheater or stage. In many examples, the environments 102 may include multiple sound zones 104. A sound zone 104 may refer to an acoustic section of the environment 102 in which different audio can be reproduced. To use a vehicle as an example, the environment 102 may include a sound zone 104 for each seating position within the vehicle.

The audio source 106 may be any form of one or more devices capable of generating and outputting different media signals including one or more channels of audio. Examples of audio sources 106 may include a media player (such as a compact disc, video disc, digital versatile disk (DVD), or BLU-RAY disc player), a video system, a radio, a cassette tape player, a wireless or wireline communication device, a navigation system, a personal computer, a portable music player device, a mobile phone, an instrument such as a keyboard or electric guitar, or any other form of media device capable of outputting media signals.

The loudspeakers 108 may include various devices configured to convert electrical signals into acoustic signals. The loudspeakers 108 may be arranged throughout the environment 102 to provide for sound output across the various sound zones 104 of the environment 102. As some possibilities, the loudspeakers 108 may include dynamic drivers having a coil operating within a magnetic field and connected to a diaphragm, such that application of the electrical signals to the coil causes the coil to move through induction and power the diaphragm. As some other possibilities, the loudspeakers 108 may include other types of drivers, such as piezoelectric, electrostatic, ribbon or planar elements. In an example, each of the sound zones 104 may be associated with one or more of the loudspeakers 108 for providing audible output into the respective sound zone 104.

The microphones 110 may include various devices configured to convert acoustic signals into electrical signals. These electrical signals may be referred to as microphone signals 112. The microphones 110 may also be arranged throughout the sound zones 104 of the environment 102 to capture voice input from users throughout the multichannel sound system 100. For instance, the microphones 110 may be available in the multichannel sound system 100 to provide for speech communication such as hands-free telephony and/or dialog with a speech assistant application. In an example, each of the sound zones 104 may include a microphone 110 or array of microphone 110 for the capture of voice in the respective sound zone 104. In an example, multiple microphones 110 are provided for each sound zone 104 position, so that beam-formed signals can be obtained for each sound zone 104 position. This may accordingly allow the voice processor system 114 to receive a directional detected sound signal for each sound zone 104 position (e.g., if a speaker is detected within the sound zone 104). By using a beam-formed signal, information about whether this is an actively speaking user in each sound zones 104 may be derived. Additional voice activity detection techniques may additionally be used to determine whether a speaker is present, such as changes in energy, spectral, or cepstral distances in the captured microphone signals 112.

The voice processor system 114 may be configured to use the loudspeakers 108 and microphones 110 for sound reinforcement within the environment 102. The voice processor system 114 may be configured to receive the microphone signals 112 from the microphones 110, which may be used by the voice processor system 114 to identify voice content in the environment 102. The voice processor system 114 may also be configured to receive reference signals 116 from the audio source 106 indicative of the audio that is played back by the loudspeakers 108.

As discussed in further detail below, the voice processor system 114 may use the reference signals 116 to perform AEC and/or AFC on the microphone signals 112 to produce processed microphone signals 118. The processed microphone signals 118 may be provided to the voice reinforcement application 120.

In an example vehicle use case, the voice reinforcement application 120 may support communication between the sound zones 104. For instance, passengers of a vehicle may use the voice processor system 114 to communicate between the front seats and the rear seats. In such an example, the voice reinforcement application 120 may direct the voice processor systems 114 to produce voice processor output signals 122 including a voice of a passenger for playback via the loudspeakers 108 to other passengers in the vehicle.

In another example, the voice reinforcement application 120 may support use of the voice processor system 114 as a sound monitor. For instance, passengers of a vehicle may use the voice processor system 114 to sing karaoke. In such an example, the voice reinforcement application 120 may direct the voice processor systems 114 to provide voice processor output signals 122 including a voice of a passenger for playback via the loudspeakers 108 to the same passenger in the vehicle. Further details of an example implementation of karaoke in a vehicle environment are discussed in detail in European Patent EP 2018034 B1, filed on Jul. 16, 2007, titled METHOD AND SYSTEM FOR PROCESSING SOUND SIGNALS IN A VEHICLE MULTIMEDIA SYSTEM, the disclosure of which is incorporated herein by reference in its entirety.

The voice processor output signals 122 may be applied to an adder 124 along with the reference signal 116 from the audio source 106, where the combined output to the adder 124 is provided to the loudspeaker 108 for playback.

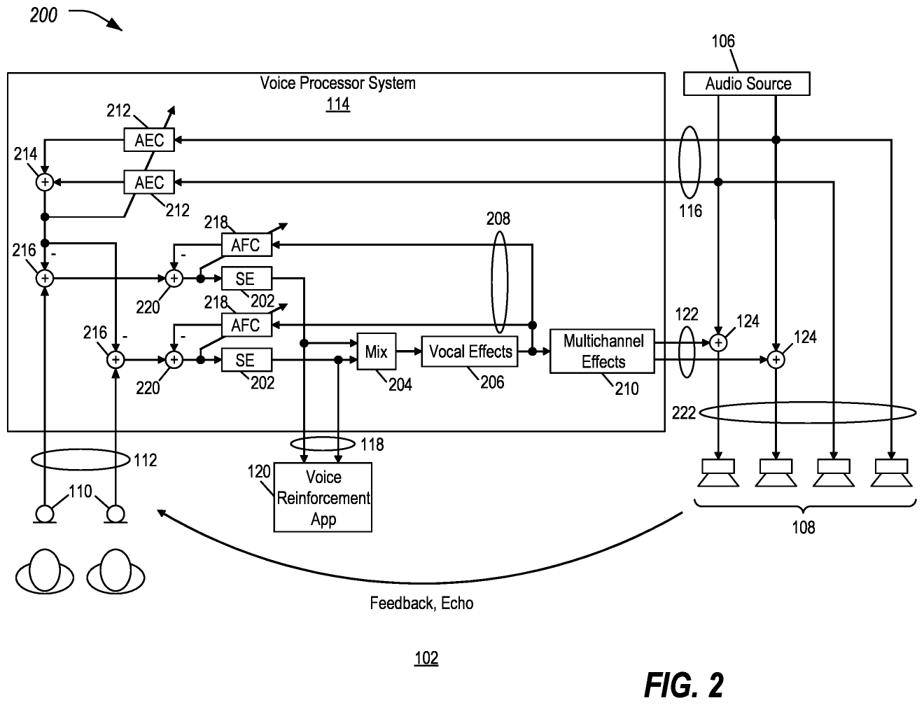

FIG. 2 illustrates further aspects of the operation of the voice processor system 114. As shown in FIG. 2, and with continuing reference to FIG. 1, the voice processor system 114 may apply various types of speech enhancement (SE) 202 to the microphone signals 112. The SE 202 may be performed to improve the quality of the received voice signal at the outset of voice processing. These SE 202 may include techniques such as noise reduction, equalization, noise dependent gain control, adaptive gain control, etc. These processed microphone signal 118 may be provided to the voice reinforcement application 120 for processing.

The voice reinforcement application 120 may be configured to control a mixer 204. The mixer 204 may be configured to receive the enhanced microphone signals 112 from the SE 202 modules, and to apply gain to the received microphone signals 112 under the direction of the voice reinforcement application 120. For instance, the voice reinforcement application 120 may direct the mixer 204 to pass one or more of the microphone signals 112 for amplification and reproduction by the loudspeakers 108. The output of the mixer 204 may be referred to as speech reinforcement.

The voice reinforcement application 120 may be configured to control the application of one or more vocal effects 206 to the mixer 204 output. These effects may include, for example, reverb, chorus, etc., that are applied to the speech reinforcement output of the mixer 204. The result of the vocal effect 206 may be referred to as per channel voice outputs 208. In some multichannel sound systems 100, multichannel effects 210 may be applied to the per channel voice outputs 208 for reproduction within the environment 102. These multichannel effects 210 may include, as some examples, panning, doubling, etc. After the mixing and application of effects, the result may be provided as voice processor output signals 122 for reproduction by the loudspeakers 108. Some sound effects (e.g., the vocal effects 206) may be applied via single-channel processing to keep central processing unit (CPU) and memory costs at a low level. Other effects may be applied as multichannel effects 210 to enrich the listening experience.

The voice processor system 114 may also perform signal processing to improve the stability of the system to compensate for acoustic feedback in the closed acoustic loop of the environment 102. In an example, the voice processor system 114 may utilize AEC 212 to combat feedback that is a result of the environment 102.

As noted herein, the microphone signals 112 may include vocal content received from the users within the sound zones 104 of the environment 102. Yet, the microphone signals 112 may also capture sound output from the loudspeakers 108 that is reflected or otherwise coupled back to the microphones 110 after some finite delay. This output of the loudspeakers 108 that is at least partially sensed by the microphones 110 may be referred to as an echo. The AEC 212 may accordingly receive reference signals 116 from the audio source 106 indicative of the audio that is played back by the loudspeakers 108. Due to the slower propagation speed of sound as compared to electric signals, the AEC 212 may receive the reference signals 116 earlier in time than the echo captured in the microphone signals 112.

The AEC 212 may apply adaptive filters to estimate, for the reference signals 116, the linear acoustic impulse response of the loudspeakers 108 in the environment 102 to microphone 110 system. Based on this echo estimate, the AEC 212 may produce an echo cancellation signal to be summed to the microphone signals 112 to reduce the echo. In one example, the AEC 212 may be performed on each of the channels of the reference signals 116 to produce channel echo cancellation signals. These channel signals may be applied to an adder 214 to produce an overall echo cancellation signal. This overall echo cancellation signal may then be applied to each of the microphone signals 112, as shown via adder 216.

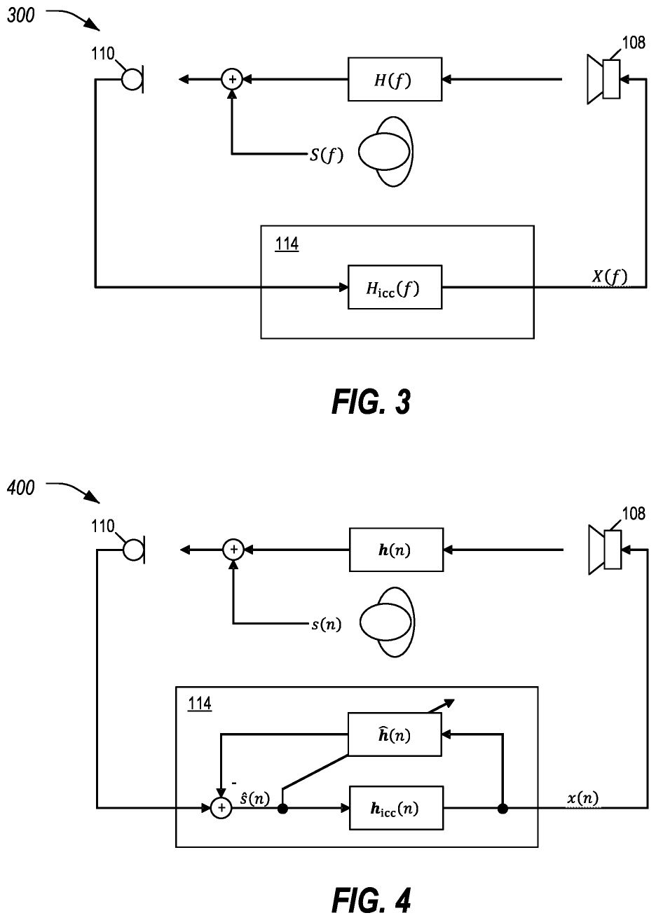

The voice processor system 114 may utilize AFC 218 to combat feedback that is the result of the operation of the voice reinforcement application 120 to reinforce voice signals within the environment 102. For each of the microphones 110, an AFC 218 component may receive the echo-canceled microphone signals 112 corresponding to that microphone 110. The AFC 218 may also receive the per channel voice outputs 208 of the vocal effects 206 as a reference. The AFC 218 may apply adaptive filters to estimate the acoustic impulse response of the loudspeakers 108 in the environment 102 to microphone 110 system for the per channel voice outputs 208. Based on the estimate, the AFC 218 may produce a feedback cancellation signal to be summed by adders 220 with the microphone signals 112 input to the SE 202 to combat the feedback. Further aspects of the operation of the AFC 218 are described in detail below with respect to FIGS. 3-6.

In some examples, the voice reinforcement application 120 may be controllable using a voice interface using input from the microphones 110. However, the microphone signal 112 may additionally include acoustic echo of the playback of the audio source 106 and the acoustic feedback of the (reverberated or otherwise effected) voice playback from the voice processor output signals 122. If the passenger stops singing and wants to use a speech assistant (in an example), the voice processor system 114 and its vocal effects 206 and multichannel effects 210 may continue running. These effects may degrade the performance of speech recognition. Thus, the described voice processor system 114 may provide the processed microphone signal 118 to the voice reinforcement application 120, before the vocal effects 206 and/or multichannel effects 210 are applied, but after the suppression of echoes using the AEC 212 and the compensation for voice feedback, after the effects via the AFC 218, and after speech enhancement that might improve the voice recognition performance due to its noise reduction, signal conditioning, etc.

Using the processed microphone signals 118, the voice reinforcement application 120 may determine the sound zone 104 (as illustrated in FIG. 1) of a user who has spoken, and a user-dedicated speech dialog may be involved in that sound zone 104. In an example, automatic speech recognition (ASR) may be used to control the voice reinforcement applications 120, e.g., skip a song, repeat a song, repeat a section, adjust vocal effects 206 and/or multichannel effects 210, add a user for voice reinforcement, turn off a user for voice reinforcement, turn off voice reinforcement for all users, request to turn on a voice processor mode to send speech to other users, etc.

The voice processor system 114 may be configured to support an arbitrary subset of the sound zones 104 utilizing the voice reinforcement. For instance, selected sound zones 104 may be added to or removed from the voice reinforcement. This may be accomplished by the users using the voice interface or other user interface of voice reinforcement application 120 to configure the mixer 204 to pass a chosen subset of its processed microphone signals 118. Thus, the user may be able to select from or ignore the processed microphone signals 118 from certain sound zones 104. In one example, by using the voice reinforcement application 120 to control the mixer 204, two or more singers can be supported at the same time, allowing for a duet or a polyphonic performance.

In some examples, the voice reinforcement application 120 may provide for performance quality evaluation. For instance, speaker separation may be applied to isolate the speech signal for each user. This isolated speech signal (which might include a singing voice) may be used for performance evaluation (e.g., pitch estimation and evaluation against a reference pitch). These evaluations may be done separately for each of the individual sound zones 104 or users. For example, performances from multiple users may be compared among the participants across multiple sound zones 104. A best singer can be detected as the singer coming closest to the reference pitch on average during the audio content played back from the audio source 106.

If the same set of loudspeakers 108 in the environment 102 are used for playback of the audio source 106 as with the playback of the reinforced voice, it may be possible to combine the hardware implementing the AEC 212 and AFC 218 functions. However, in many applications, the channels for the AEC 212 and the channels for the AFC 218 may differ because a different set of the loudspeakers 108 may be used for echo cancellation as compared to feedback cancellation. For instance, there may be many loudspeakers 108 in the environment 102 for use in reproducing audio, but it may be impractical to utilize all these loudspeakers 108 for voice reinforcement due to the processing requirements of doing so. As a result, a common adaptive filter may not be a feasible solution, and separate adaptive filters with separate adaptation control may be used for the AEC 212 and the AFC 218 functions.

As shown in FIG. 2, the illustrated voice processor system 114 incorporates separate methods for AEC 212 and AFC 218. Thus, it is possible for the voice processor system 114 to use a different subset of loudspeakers 108 in the environment 102 for voice reinforcement as compared to for entertainment playback. (As shown in the example of FIG. 2, half of loudspeaker outputs 222 to the loudspeaker 108 are used for voice reinforcement, while the other half are not.) The acoustic echo components for audio from the audio sources 106 and voice from the microphones 110 may be treated separately: music may be treated by the AEC 212, while the voice may be treated with AFC 218 (and/or other methods that such as feedback suppression).

As noted above, the voice reinforcement application 120 may be configured to perform a voice processor function. In such an example, the voice reinforcement application 120 may select loudspeakers 108 that are far away in the environment 102 from the user speaking into the microphones 110. This may be done to avoid acoustic feedback of the loudspeakers 108 back into the microphones 110 in combination with the sound reinforcement.

However, for voice reinforcement use cases such as karaoke, it is desirable to provide sound reinforcement using the loudspeakers 108 local to the user who is speaking. For instance, a singer may desire to hear his or her own voice using the loudspeakers 108 as a sound monitor. In such an example, the voice reinforcement applications 120 may determine the sound zone 104 corresponding to the user and may direct the sound reinforcement to the loudspeakers 108 for the corresponding sound zone 104. In voice reinforcement the distance between a loudspeaker 108 and its associated open microphone 110 is small in comparison to the distance for a voice processor use case. This may increase the risk of instability due to the higher acoustic coupling. Thus, additional aspects may be required to combat acoustic feedback for karaoke or other voice reinforcement applications 120 where the speaker is close to the loudspeakers 108. These additional aspects may include, for example, a step-size control for acoustic feedback cancellation with artificially added reverberation (or other vocal effects 206).

FIG. 3 illustrates an example portion 300 of the multichannel sound system 100 illustrating an example of electro-acoustic feedback within the multichannel sound system 100. Regarding the electro-acoustic feedback, the voice processor system 114 may operate in a closed electro-acoustic loop. Instability may occur if the gain of the voice processor system 114 exceeds a stability limit of the multichannel sound system 100. Mathematically, let a transfer function for resonance be defined as follows:

$${H}_{res} ( f ) = \frac{X ( f )}{S ( f )} = \frac{{H}_{icc} ( f )}{1 - {H}_{icc} ( f ) \cdot H ( f )} ,$$

where:

f is a continuous frequency of resonance;

S(f) is a local speech signal from a user in a sound zone 104;

X(f) is a signal from a loudspeaker 108;

H(f) is a transfer function of the path between the loudspeaker 108 and the microphone 110; and

H_{icc}(f)is a transfer function of the voice processor system 114.

In such an example, the stability limit may be mathematically defined as:

|H_{icc}(f)·H(f)|<1

The system may accordingly be stable so long as the open loop gain is less than unity.

FIG. 4 illustrates an example portion 400 of the multichannel sound system 100 illustrating an example of the user of AFC 218 to combat the electro-acoustic feedback within the multichannel sound system 100. The cancellation of the acoustic feedback may be performed by estimation of the impulse response of the environment 102 using an adaptive filter (e.g., a normalized-least mean square (NLMS algorithm) in an example.

Referring more specifically to FIG. 4, let n refer to a discrete time index. s(n) may refer to a local speech signal, e.g., from a user in a sound zone 104. ŝ(n) may refer to an estimation of the local speech signal (with feedback removed). x(n) may refer to the loudspeaker output 222 signal to drive the loudspeaker 108. h(n) may refer to the actual impulse response from the loudspeaker 108 to the microphone 110, while ĥ(n) refers to an estimation of the impulse response from the loudspeaker 108 to the microphone 110. h_{icc}(n) may refer to the impulse response of the voice processor system 114. It should be noted that, in other examples, the adaptive filter algorithm may be implemented in the frequency domain, e.g., using frequency-domain signal processing.

In general, the adaptive filters converge best if s(n) and x(n) are orthogonal. However, for performing voice reinforcement, local speech may intentionally be equal to or at least strongly correlated to the signal to the loudspeaker 108. In such a condition, the adaptive filter may converge towards a bias due to the high correlation between the local and the excitation signals.

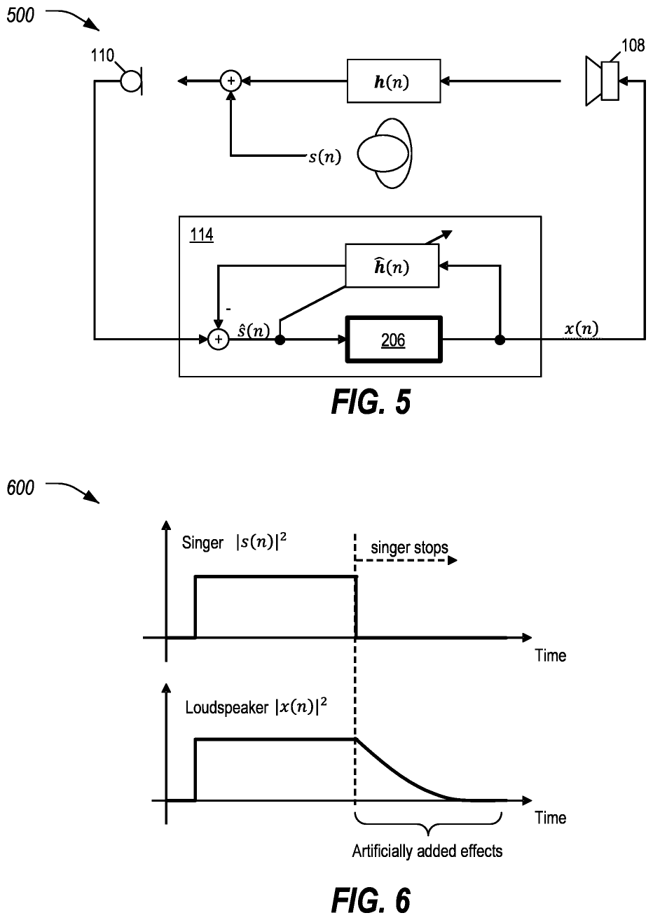

FIG. 5 illustrates an example of a portion 500 of the multichannel sound system 100 illustrating step-size control for acoustic feedback cancellation with artificially added reverberation. Reverberation effects are an important vocal effect 206, used in various styles of music. Therefore, the sound of the voice reinforcement application 120 may be improved by adding artificial reverb to the speaker or singer's voice. This reverberation effect may be applied by the vocal effects 206 to the processed microphone signals 118 within the voice processor system 114, as discussed above.

Significantly, the artificially added reverberation may be used to improve the convergence of the adaptive filter that is used for the feedback cancellation. As soon as the singer stops, only the reverberation is played back via the loudspeaker 108. Mathematically:

During Reverberation:

s(n)=0

x(n)=Reverberation

FIG. 6 illustrates an example graph 600 of local speech s(n) and loudspeaker signal x(n). Significantly, the loudspeakers 108 continue to produce artificial reverberation for a period of time after the speaker has become silent. When local speech stops, this reverberant energy provided by the vocal effects 206 may decay exponentially. There is still signal from the loudspeakers 108 during this time but without any local speech. During this reverberation period, where the user is no longer speaking or singing, there is no correlation between s(n) and x(n).

Using this remaining reverberant energy when the speaker is silent, an adaptive algorithm such as the NLMS can quickly converge to the desired solution during this time. A step-size control mechanism may be utilized to increases the adaption process during times of reverberation and to slow down the adaption process during local speech/singing. For instance, if reverberation is detected in the microphone signals 112 and/or if no speech is detected in the microphone signals 112, the adaptation step size may be increased to allow the adaptive algorithm to converge. However, if speech is detected in the microphone signals 112, the adaptation step size may be slowed to reduce the possibility of converging towards a bias due to the high correlation between the local and the excitation signals.

With this additional enhancement, the reverb applied to the processed microphone signal 118 may be used to both improve the subject sound of the voice reinforcement and to improve the overall operation of the AFC 218. It should be noted that while this technique for step-size control is discussed with respect to reverb, it is possible to perform similar techniques based on the use of other effects, such as delay or chorus.

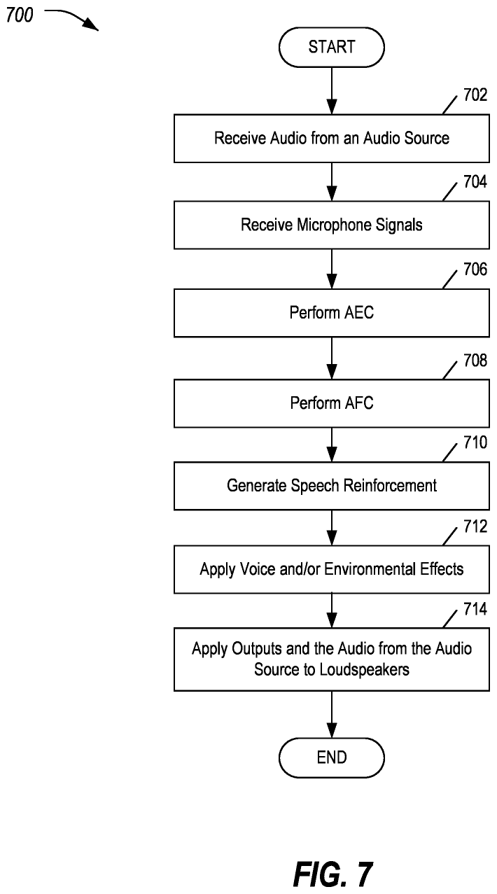

FIG. 7 illustrates an example process 700 for providing voice reinforcement within an environment 102 having multiple sound zones 104. In an example, the process 700 may be performed by the voice processor system 114 in the context of the multichannel sound system 100. For instance, the process 700 may be performed by the voice processor system 114 to provide for karaoke in a vehicle environment 102.

At operation 702, the voice processor system 114 receives audio from an audio source 106. The audio source 106 may be any form of one or more devices capable of generating and outputting different media signals including one or more channels of audio. The audio from the audio source 106 may be received as reference signals 116 for processing by the voice processor system 114.

At operation 704, the voice processor system 114 receives microphone signals 112 from the microphones 110. In an example, each of the sound zones 104 may include a microphone 110 or array of microphone 110 for the capture of voice signals in the respective sound zone 104.

At operation 706, the voice processor system 114 performs AEC 212 to produce echo-canceled microphone signals. In an example, the AEC 212 may apply adaptive filters to estimate, for the reference signals 116, the linear acoustic impulse response of the loudspeakers 108 in the environment 102 to microphone 110 system. Based on this echo estimate, the AEC 212 may produce an echo cancellation signal to be summed to the microphone signals 112 to reduce the echo.

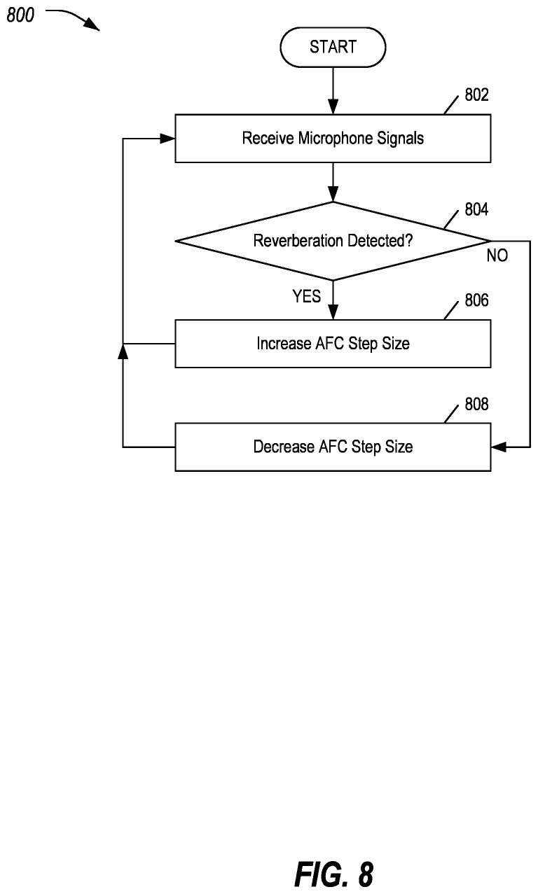

At operation 708, the voice processor system 114 performs AFC 218 on the echo-canceled microphone signals. In an example, the voice processor system 114 may utilize AFC 218 to combat feedback that is the result of the operation of the voice reinforcement application 120 to reinforce voice signals within the environment 102. The AFC 218 may produce the processed microphone signal 118 for further use. Further aspects of the operation of the AFCs 218 are discussed with respect to FIG. 8 below.

At operation 710, the voice processor system 114 generates speech reinforcement. In an example, the voice reinforcement application 120 may receive commands from users of the voice processor system 114 in the environment 102. These commands may allow the voice reinforcement application 120 to set the mixer 204 to generate speech reinforcement for one or more users in the one or more sound zones 104. For instance, the voice reinforcement application 120 may direct the mixer 204 to pass one or more of the microphone signals 112 for amplification and reproduction by the loudspeakers 108.

At operation 712, the voice processor system 114 applies vocal effects 206 to the speech reinforcement to generate per channel voice outputs 208. In many examples, these vocal effects 206 may include reverb. Additionally or alternately, these vocal effects 206 may include chorus, pitch correction, introduction of sound effects, etc.

At operation 714, the voice processor system 114 provides the loudspeaker outputs 222 and the audio from the audio source 106 to the loudspeakers 108 for reproduction in the environment 102. Thus, the users in the sound zones 104 of the environment 102 may enjoy the reproduction of voice enhancement with a minimum of feedback.

After operation 714, the process 700 ends. It should be noted that while the process 700 is shown as a linear process, the process 700 may be performed continuously. Moreover, it should also be noted that one or more operations of the process 700 may be performed concurrently and/or out of order from the description of the process 700.

FIG. 8 illustrates an example process 800 for the operation of the AFC 218 of the voice processor system 114. As with the process 700, the process 800 may be performed by the voice processor system 114 in the context of the multichannel sound system 100.

At operation 802, and similar to that of operation 704, the voice processor system 114 receives microphone signals 112. At operation 804, the voice processor system 114 determines whether reverberation is present and/or lack of speech is detected in the microphone signals 112. The determination of whether reverberation is present may be performed using various techniques. As an example, determining presence of reverberation may involve measuring a persistence of sound, or echo, such as to measure how quickly a sound level drops when a loud sound is made (e.g., the time it takes the sound energy to drop by 60 dB or another factor). The determination of whether there is voice in the microphone signals 112 may be performed using various techniques discussed herein, such as capturing beam-formed signals for each sound zone 104 position to determine a location of a speaker, analysis of the microphone signals 112 to identify changes in energy, spectral, or cepstral distances in the captured microphone signals 112, etc. If reverberation and/or no speech is detected, control passes to operation 806. If speech is detected, however, control passes to operation 808.

At operation 806, the voice processor system 114 increases the step size of the adaptive algorithm of the AFC 218. No speech may be included in the microphone signals 112 at this point in time, but there may still be remaining reverberant energy as applied by the vocal effects 206 in the microphone signals 112. Because this signal no longer correlated to local speech, an adaptive algorithm such as the NLMS can quickly converge to the desired solution during this time. Thus, the reverberation effect added to improve the vocal quality may be used to improve the adjustment of the AFC filter with reverb-based step size control. After operation 806, control returns to operation 802.

At operation 808, the voice processor system 114 decreases the step size of the adaptive algorithm of the AFC 218. Thus, if speech is detected in the microphone signals 112, the adaptation step size may be slowed to reduce the possibility of converging towards a bias due to the high correlation between the local and the excitation signals. After operation 808, control returns to operation 802.

The signal processing means described in this application may be implemented as software on a digital signal processor, may be provided as separate processing chips, which may for example be implemented on a card that can be connected to the multimedia bus system of a computing device, or may be provided in other forms known to the person skilled in the art.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C #, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for sound signal processing in a vehicle multimedia system, comprising:
loudspeakers configured to reproduce, within an environment, an audio signal from an audio source and a reinforced voice signal;
at least one microphone for detection of a microphone signal, where the microphone signal includes a first voice signal component that corresponds to uttered speech, a second voice signal component that corresponds to the reinforced voice signal as reproduced by the loudspeakers, and an audio signal component corresponding to the audio signal as reproduced by the loudspeakers; and
a voice processor system configured to
receive the microphone signal from the at least one microphone,
perform acoustic echo cancellation (AEC) of the microphone signal to produce an echo cancelled microphone signal, the AEC using first adaptive filters to estimate and cancel feedback that is a result of the environment,
perform acoustic feedback cancellation (AFC) of the echo cancelled microphone signal to produce a processed microphone signal, the AFC using second adaptive filters to estimate and cancel feedback resulting from application of the reinforced voice signal within the environment,
reinforce the uttered speech in the processed microphone signal to produce the reinforced voice signal, and
apply the reinforced voice signal and the audio signal to the loudspeakers for reproduction in the environment.

2. The system of claim 1, wherein the AEC is performed using a first subset of the loudspeakers, and the AFC is performed using a second, different subset of the loudspeakers.

3. The system of claim 1, wherein the voice processor system is further configured to perform automatic speech recognition (ASR) on the processed microphone signal to receive commands to control the voice processor system.

4. The system of claim 3, wherein the commands include one or more of to: skip a song, repeat a song, repeat a section, adjust vocal effects and/or multichannel effects, add a user for voice reinforcement, turn off a user for voice reinforcement, turn off voice reinforcement for all users, or to request to turn on a voice processor mode to send uttered speech from one user to another of the users.

5. The system of claim 1, wherein the environment includes a plurality of sound zones, the at least one microphone includes a first microphone in a first sound zone of the plurality of sound zones and a second microphone in a second sound zone of the plurality of sound zones, and the voice processor system is further configured to:
reinforce first speech received to the first microphone to produce a first aspect of the reinforced voice signal in the first sound zone; and
reinforce second speech received to the second microphone to produce a second component of the reinforced voice signal in the second sound zone.

6. The system of claim 5, wherein the first speech is received from a first singer, the second speech is received from a second singer, and the voice processor system is further configured to:
perform an evaluation of pitch of each of the first speech and the second speech against a reference pitch; and
identify whether the first singer or the second singer provided a performance closest to the reference pitch.

7. The system of claim 1, wherein the voice processor system is further configured to apply vocal effects to the reinforced voice signal, the vocal effects including the addition of artificial reverberation.

8. The system of claim 7, wherein the voice processor system is further configured to
increase a step size of adjustment of the second adaptive filters responsive to detection of reverberation in the processed microphone signal; and
decrease the step size of the adjustment of the second adaptive filters responsive to a lack of reverberation in the processed microphone signal.

9. A method for sound signal processing in a vehicle multimedia system, comprising:
receiving a microphone signal from at least one microphone, the microphone signal including a first voice signal component that corresponds to uttered speech, a second voice signal component that corresponds to a reinforced voice signal as reproduced by loudspeakers in an environment, and an audio signal component corresponding to an audio signal as reproduced by the loudspeakers;
performing acoustic echo cancellation (AEC) of the microphone signal to produce an echo cancelled microphone signal, the AEC using first adaptive filters to estimate and cancel feedback that is a result of the environment;
performing acoustic feedback cancellation (AFC) of the echo cancelled microphone signal to produce a processed microphone signal, the AFC using second adaptive filters to estimate and cancel feedback resulting from application of the reinforced voice signal within the environment;
reinforcing the uttered speech in the processed microphone signal to produce the reinforced voice signal; and
applying the reinforced voice signal and the audio signal to the loudspeakers for reproduction in the environment.

10. The method of claim 9, further comprising performing the AEC using a first subset of the loudspeakers, and performing the AFC using a second, different subset of the loudspeakers.

11. The method of claim 9, further comprising performing automatic speech recognition (ASR) on the processed microphone signal to receive commands to control the vehicle multimedia system.

12. The method of claim 11, wherein the commands include one or more of to: skipping a song, repeating a song, repeating a section, adjusting vocal effects and/or multichannel effects, adding a user for voice reinforcement, turning off a user for voice reinforcement, turning off voice reinforcement for all users, or requesting to turn on a voice processor mode to send uttered speech from one user to another of the users.

13. The method of claim 9, wherein the environment includes a plurality of sound zones, the at least one microphone includes a first microphone in a first sound zone of the plurality of sound zones and a second microphone in a second sound zone of the plurality of sound zones, and further comprising:
reinforcing first speech received to the first microphone to produce a first aspect of the reinforced voice signal in the first sound zone; and
reinforcing second speech received to the second microphone to produce a second component of the reinforced voice signal in the second sound zone.

14. The method of claim 13, wherein the first speech is received from a first singer, the second speech is received from a second singer, and further comprising:
performing an evaluation of pitch of each of the first speech and the second speech against a reference pitch; and
identifying whether the first singer or the second singer provided a performance closest to the reference pitch.

15. The method of claim 9, further comprising applying vocal effects to the reinforced voice signal, the vocal effects including the addition of artificial reverberation.

16. The method of claim 15, further comprising:
increasing a step size of adjustment of the second adaptive filters responsive to detection of reverberation in the microphone signal; and
decreasing the step size of the adjustment of the second adaptive filters responsive to a lack of reverberation in the microphone signal.

17. A non-transitory computer-readable medium comprising instructions for sound signal processing in a vehicle multimedia system that, when executed by a voice processor system, cause the voice processor system to perform operations including to:
receive a microphone signal from at least one microphone, the microphone signal including a first voice signal component that corresponds to uttered speech, a second voice signal component that corresponds to a reinforced voice signal as reproduced by loudspeakers in an environment, and an audio signal component corresponding to an audio signal as reproduced by the loudspeakers;
perform acoustic echo cancellation (AEC) of the microphone signal to produce an echo cancelled microphone signal, the AEC using first adaptive filters to estimate and cancel feedback that is a result of the environment;
perform acoustic feedback cancellation (AFC) of the echo cancelled microphone signal to produce a processed microphone signal, the AFC using second adaptive filters to estimate and cancel feedback resulting from application of the reinforced voice signal within the environment;
reinforce the uttered speech in the processed microphone signal to produce the reinforced voice signal; and
apply the reinforced voice signal and the audio signal to the loudspeakers for reproduction in the environment.

18. The medium of claim 17, further comprising instructions that, when executed by the voice processor system, cause the voice processor system to perform operations including to perform the AEC using a first subset of the loudspeakers, and performing the AFC using a second, different subset of the loudspeakers.

19. The medium of claim 17, further comprising instructions that, when executed by the voice processor system, cause the voice processor system to perform operations including to perform automatic speech recognition (ASR) on the processed microphone signal to receive commands to control the vehicle multimedia system.

20. The medium of claim 19, wherein the commands include one or more of to: skipping a song, repeating a song, repeating a section, adjusting vocal effects and/or multichannel effects, adding a user for voice reinforcement, turning off a user for voice reinforcement, turning off voice reinforcement for all users, or requesting to turn on a voice processor mode to send uttered speech from one user to another of the users.

21. The medium of claim 17, wherein the environment includes a plurality of sound zones, the at least one microphone includes a first microphone in a first sound zone of the plurality of sound zones and a second microphone in a second sound zone of the plurality of sound zones, and further comprising instructions that, when executed by the voice processor system, cause the voice processor system to perform operations including to:
reinforcing first speech received to the first microphone to produce a first aspect of the reinforced voice signal in the first sound zone; and
reinforcing second speech received to the second microphone to produce a second component of the reinforced voice signal in the second sound zone.

22. The medium of claim 21, wherein the first speech is received from a first singer, the second speech is received from a second singer, and further comprising instructions that, when executed by the voice processor system, cause the voice processor system to perform operations including to:
performing an evaluation of pitch of each of the first speech and the second speech against a reference pitch; and
identifying whether the first singer or the second singer provided a performance closest to the reference pitch.

23. The medium of claim 17, further comprising instructions that, when executed by the voice processor system, cause the voice processor system to perform operations including to applying vocal effects to the reinforced voice signal, the vocal effects including the addition of artificial reverberation.

24. The medium of claim 23, further comprising instructions that, when executed by the voice processor system, cause the voice processor system to perform operations including to:
increasing a step size of adjustment of the second adaptive filters responsive to detection of reverberation in the processed microphone signal; and
decreasing the step size of the adjustment of the second adaptive filters responsive to a lack of reverberation in the processed microphone signal.
